(19) United States
(12) Patent Application Publication
(10) Pub. No.: US 2004/0024780 A1
(43) Pub. Date: Feb. 5, 2004

(54) Method, system and program product for generating a content-based table of contents

(75) Inventors: Lalitha Agnihotri, Fishkill, NY (US); Nevenka Dimitrova, Yorktown Heights, NY (US); Srinivas Gutta, Yorktown Heights, NY (US); Dongge Li, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/210,521

(22) Filed: Aug. 1, 2002

(51) Int. Cl. G06F 17/00

(52) U.S. Cl. 707/104.1

(57) ABSTRACT

The present invention provides a method, system and program product for generating a content-based table of contents for a program. Specifically, under the present invention the genre of a program having sequences is determined. Once the genre has been determined, each sequence is assigned a classification. The classifications are assigned based on video content, audio content and textual content within the sequences. Based on the genre and the classifications, keyframe(s) are selected from the sequences for use in a content-based table of contents.

### BACKGROUND OF THE INVENTION

1. Field of the Invention

The present invention generally relates to a method, system and program product for generating a content-based table of contents for a program. Specifically, the present invention allows keyframes from sequences of a program to be selected based on video, audio, and textual content within the sequences.

2. Background Art

With the rapid emergence of computer and audio/video technology, consumers are increasingly being provided with additional functionality in consumer electronic devices. Specifically, devices such as set-top boxes for viewing cable or satellite television programs, and hard-disk recorders (e.g., TIVO) for recording programs have become prevalent in many households. In providing increased functionality to consumers many needs are addressed. One such need is the desire of the consumer to access a table of contents for a particular program. A table of contents could be useful for example, when a consumer begins watching a program that has already commenced. In this case, the consumer could reference the table of contents to see how far along the program is, what sequences have occurred, etc.

Heretofore, systems have been provided for indexing or generating a table of contents for a program. Unfortunately, no existing system allows a table of contents to be generated based on the content of the program. Specifically, no existing system allows a table of contents to be generated from keyframes that are selected based on the determined genre of the program and classification of each sequence. For example, if a program is a “horror movie” having a “murder sequence,” certain keyframes (e.g., the first frame and the fifth frame) might be selected from the sequence due to the fact it is a “murder sequence” within a “horror movie.” To this extent, the keyframes selected from the “murder sequence” could differ from those selected from a “dialogue sequence” within the program. No existing system provides such functionality.

In view of the foregoing, there exists a need for a method, system and program product for generating a content-based table of contents for a program. To this extent, a need exists for the genre of a program to be determined. A need also exists for each sequence in the program to be classified. Still yet, a need exists for a set of rules to be applied to the program to determine appropriate keyframes for the table of contents. A need also exists for the set of rules to correlate the genre with the classifications and the keyframes.

### SUMMARY OF THE INVENTION

In general, the present invention provides a method, system and program product for generating a content-based table of contents for a program. Specifically, under the present invention the genre of a program having sequences of content is determined. Once the genre has been determined, each sequence is assigned a classification. The classifications are assigned based on video content, audio content and textual content within the sequences. Based on the genre and the classifications, keyframe(s) (also known as keyelements or keysegments) are selected from the sequences for use in content-based a table of contents.

According to a first aspect of the present invention, a method for generating a content-based table of contents for a program is provided. The method comprises: (1) determining a genre of a program having sequences of content; (2) determining a classification for each of the sequences based on the content; (3) identifying keyframes within the sequences based on the genre and the classification; and (4) generating a content-based table of contents based on the keyframes.

According to a second aspect of the present invention, a method for generating a content-based table of contents for a program is provided. The method comprises: (1) determining a genre of a program having a plurality of sequences, wherein the sequences include video content, audio content, and textual content; (2) assigning a classification to each of the sequences based on the video content, the audio content, and the textual content; (3) identifying keyframes within the sequences based on the genre and the classifications by applying a set of rules; and (4) generating a content-based table of contents based on the keyframes.

According to a third aspect of the present invention, a system for generating a content-based table of contents for a program is provided. The system comprises: (1) a genre system for determining a genre of a program having a plurality of sequences of content; (2) a classification system for determining a classification for each of the sequences of a program based on the content; (3) a frame system for identifying keyframes within the sequences based on the genre and the classifications; and (4) a table system for generating a content-based table of contents based on the keyframes.

According to a fourth aspect of the present invention, a program product stored on a recordable medium for generating a content-based table of contents for a program is provided. When executed, the program product comprises: (1) program code for determining a genre of a program having a plurality of sequences of content; (2) program code for determining a classification for each of the sequences of a program based on the content; (3) program code for identifying keyframes within the sequences based on the genre and the classifications; and (4) program code for generating a content-based table of contents based on the keyframes.

Therefore, the present invention provides a method, system and program product for generating a content-based table of contents for a program.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computerized system having a content processing system according to the present invention.

FIG. 2 depicts the classification system of FIG. 1.

FIG. 3 depicts an exemplary table of contents generated according to the present invention.

FIG. 4 depicts a method flow diagram according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system and program product for generating a content-based table of contents for a program. Specifically, under the present invention the genre of a program having sequences of content is determined. Once the genre has been determined, each sequence is assigned a classification. The classifications are assigned based on video content, audio content and textual content within the sequences. Based on the genre and the classifications, keyframe(s) (e.g., also known as keysegments or keyelements) are selected from the sequences for use in a content-based table of contents.

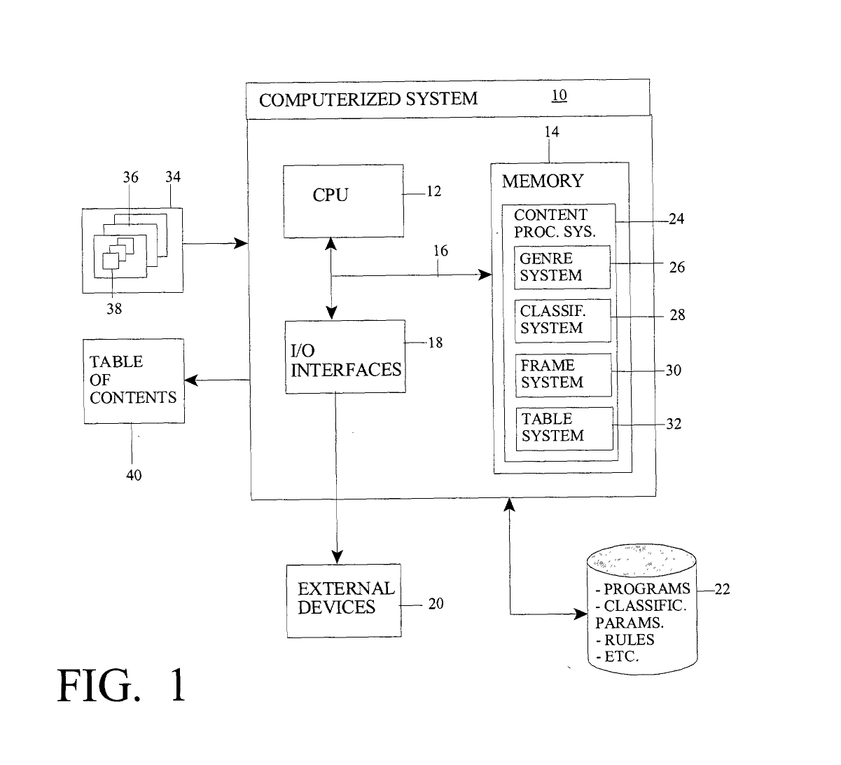

Referring now to FIG. 1, computerized system 10 is shown. Computerized system 10 is intended to be representative of any electronic device capable of “implementing” a program 34 that includes audio and/or video content. Typical examples include a set-top box for receiving cable or satellite television signals, or a hard-disk recorder (e.g., TIVO) for storing programs. In addition, as used herein, the term “program” is intended to mean any arrangement of audio, video and/or textual content such as a television show, a movie, a presentation, etc. As shown, program 34 typically includes one or more sequences 36 that each has one or more frames or elements 38 of audio, video and/or textual content.

As shown, computerized system 10 generally includes central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in computerized system 10 and likewise may comprise any known type of transmission link, including electrical, optical, wireless, etc. In addition, although not shown, additional components, such as cache memory, communication systems, system software, etc., may be incorporated into computerized system 10.

Database 22 may provide storage for information necessary to carry out the present invention. Such information could include, among other things, programs, classification parameters, rules, etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

Stored in memory 14 of computerized system 10 is content processing system 24 (shown as a program product). As depicted, content processing system 24 includes genre system 26, classification system 28, frame system 30 and table system 32. As indicated above, content processing system 24 generates a content-based table of contents for program 34. It should be understood that content system 10 has been compartmentalized as shown for in a fashion for readily describing the invention. The teachings of the invention, however, should not be limited to any particular organization, and functions illustrated as being part of any particular system, module, etc., may be provided via other systems, modules, etc.

Once program 34 has been provided, genre system 26 will determine the genre thereof. For example, if program 34 were a “horror movie,” genre system 26 would determine the genre to be “horror.” To this extent, genre system 26 can include a system for interpreting a “video guide” for determining the genre of program 34. Alternatively, the genre can be included as data with program 34 (e.g., as a header). In this case, genre system 26 will read the genre from the header. In any event, once the genre of program 34 has been determined, classification system 28 will classify each of the sequences 36. In general, classification involves reviewing the content within each frame, and assigning a particular classification thereto using classification parameters stored in database 22.

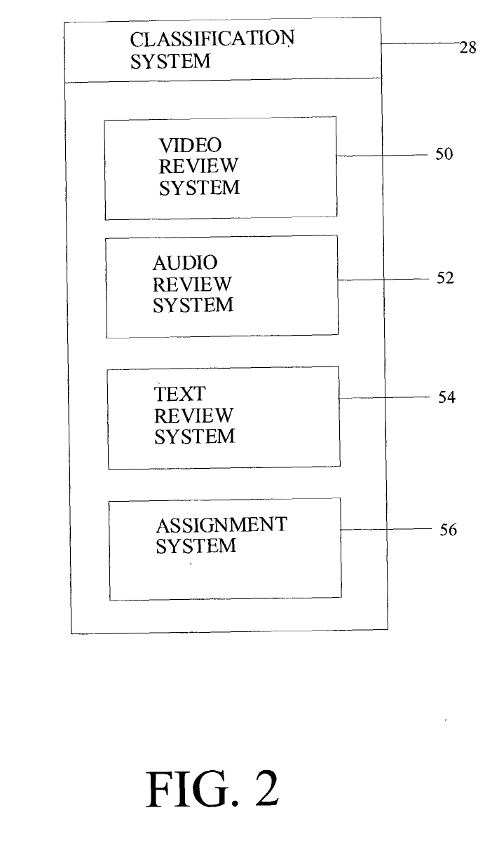

Referring to FIG. 2, a more detailed diagram of classification system 28 is shown. As depicted, classification system 28 includes video review system 50, audio review system 52, text review system 54 and assignment system 56. Video review system 50 and audio review system 52 will review the video and audio content of each sequence, respectively, in an attempt determines each sequence's classification. For example, video review system 50 could review facial expressions, background scenery, visual effects, etc., while audio review system 52 could review dialogue, explosions, clapping, jokes, volume levels, speech pitch, etc. in an attempt to determine what is transpiring in each sequence. Text review system 54 will review the textual content within each sequence. For example, text review system could derive textual content from closed captions or from dialogue during the sequence. To this extent, text review system 54 could include speech recognition software for deriving/extracting the textual content

In any event, the video, audio, and textual content (data) gleaned from the review would be applied to the classification parameters in database 22 to determine a classification for each sequence. For example, assume that program 34 is a “horror movie.” Also assume that a particular sequence in program 34 has video content showing one individual stabbing another individual and audio content comprised of screams. The classification parameters generally correlate genres with, video content, audio content, and classifications. In this example, the classification parameters could indicate a classification of “murder sequence.” Thus, for example, the classification parameters could resemble the following:

| | VIDEO | AUDIO | TEXTUAL | CLASSI- |
|---|---|---|---|---|
| GENRE | CONTENT | CONTENT | CONTENT | FICATION |
| Horror | Individual | Dialogue is | Kill, | Murder Sequence |
| Movie | using deadly | screaming, | murder. | |
| | force against | decibel level | | |
| | another | above 20 | | |
| | individual, | decibels. | | |
| | Individual | Dialogue is | Stop, | Chase Sequence |
| | pursuing | heavy | catch. | |
| | another | breathing. | | |
| | individual | Explosions | | |
| | | are | | |
| | | occurnng. | | |
| | | Music for | | |
| | | sequence is | | |
| | | fast paced. | | |
| | Individual | Dialogue is | Caught, | Capture Sequence |
| | apprehending | normal. | Captured. | |
| | another | Music for | | |
| | individual | sequence is | | |
| | | slow paced | | |

Once the classifications for the sequences have been determined, the classifications will be assigned to the corresponding sequences via assignment system 54. It should be understood that the above classification parameters are intended to be illustrative only and many equivalents are possible. Moreover, it should be understood that many approaches could be taken in classifying a sequence. For example, the method(s) disclosed in M. R. Naphade et al., “Probabilistic multimedia objects (multijects): A novel approach to video indexing and retrieval in multimedia systems”, in Proc. of ICIP'98, 1998, vol.3, pp. 536-540 (herein incorporated by reference), could be implemented under the present invention.

After each sequence has been classified, frame system 30 (FIG. 1) will access a set of rules (i.e., one or more rules) in database 22 to determine the keyframes from each sequence that should be used for table of contents 40. Specifically, table of contents 40 will typically include representative keyframes from each sequence. In order to select the keyframes which best highlight the underlying sequence, frame system 30 will apply a set of rules that maps (i.e., correlates) the determined genre, with the determined classifications and the appropriate keyframes. For example, a certain types of segment within a certain genre of program could be best represented by keyframes taken from the beginning and the end of the segment. The rules provide a mapping function between the genre, the classifications and the most relevant parts (keyframes) of the sequences. Shown below is an exemplary set of mapping rules that could be applied if program 34 is a “horror movie.”

| GENRE | CLASSIFICATION | KEYFRAME (S) |
|---|---|---|
| Horror Movie | Murder Sequence | A and Z |
| | Chase Sequence | M |
| | Capture Sequence | A, M and Z |

Thus, for example, if program 34 is a “horror movie,” and one of the sequences was a “murder sequence,” the set of rules could dictate that the beginning and the end of the sequence are the most important. Therefore, keyframes A and Z are to be retrieved (e.g., copied, referenced, etc.) for use in the table of contents. It should be understood that, similar to the classification parameters shown above, the set of rules depicted above are for illustrative purposes only and not intended to be limiting.

In determining what keyframes are ideal for the rules, various methods could be implemented. In a typical embodiment, as shown above, the keyframes are selected based upon sequence classification (type), audio content (e.g., silence, music, etc.), video content (e.g., number of faces in a scene), camera motion (e.g., pan, zoom, tilt, etc.) and genre. To this extent, keyframes could be selected by first determining which sequences are the most important for a program (e.g., a “murder sequence” for a “horror movie”), and then by determining which keyframes are the most important for each of those sequences. In making these determinations, the present invention could implement the following Frame Detail calculation:

| | |
|---|---|
| Frame Detail = | 0 if (# of edges + texture + # of objects) < threshold1 |
| | 1 if threshold1 < (·0 of edges + texture + # of objects)> |
| | threshold 2 |
| | 0 if(# of edges + texture + # of objects) > threshold2 |

Once frame detail for a frame has been calculated, it can then be combined with “importances” and variable weighting factors (w) to yield Frame Importance. Specifically, in calculating Frame Importance, preset weighting factors are applied to different pieces of information that exists for a sequence. Examples of such information include sequence importance, audio importance, facial importance, frame detail and motion importance. These pieces of information represent different modalities that need to be combined to yield a single number for a frame. In order to combine these, each is weighted and added together to yield an importance measure of the frame. Accordingly, Frame Importance can be calculated as follows:

Frame Importance=w1*sequence importance+w2*audio importance+w3*facial importance+w4*frame detail+w5*motion importance.

Motion importance=1 for first and last frame in case of zooming and zoom out, 0 for all other frames.

1 for middle frame in case of pan, 0 for all other frames.

1 for all frames in case of static, tilt, dolly, etc.

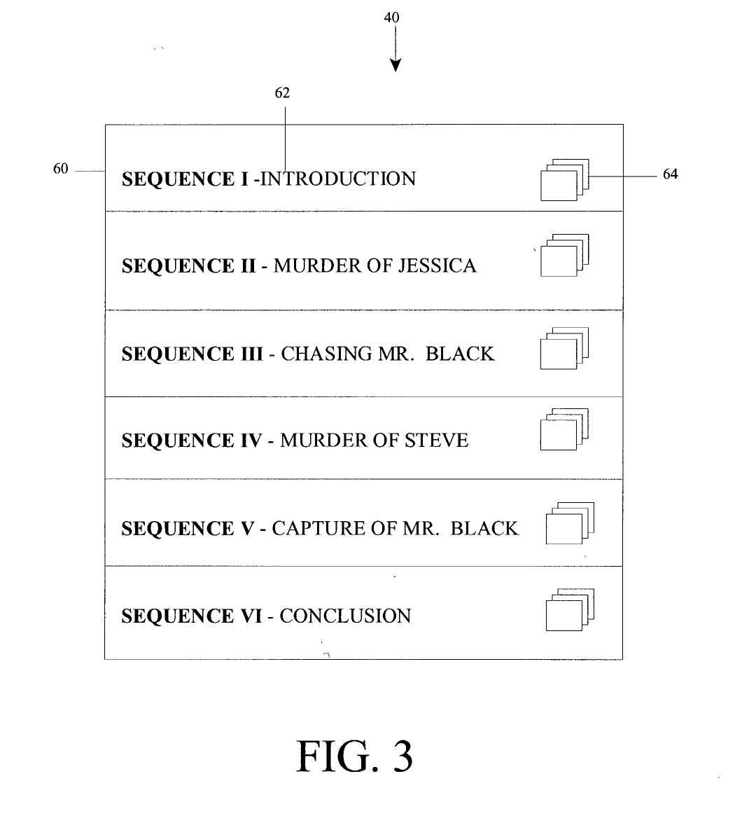

After the keyframes have been selected, table system 32 will use the keyframes to generate a content-based table of contents. Referring now to FIG. 3, an exemplary content-based table of contents 40 is shown. As depicted, table of contents 40 could include a listing 60 for each sequence. Each listing 60 includes a sequence title 62 (which could typically include the corresponding sequence classification) and corresponding keyframes 64. The keyframes 64 are those selected based on a set (i.e., 1 or more) of rules as applied to each sequence in light of the genre and classifications. For example, using the set of rules illustrated above, the keyframes for “SEQUENCE II—Murder of Jessica” would be frames one and five of the sequence (i.e., since the sequence was classified as a “murder sequence.” Using a remote control, or other input device a user could select and view the keyframes 64 in each listing. This would present the user with a quick synopsis of the particular sequence. Such a table of contents 40 could be useful to a user for many reasons such as browsing a program quickly, jumping to a particular point in a program and viewing highlights of a program. For example, if program 34 is a “horror movie” showing on a cable television network, user could utilize the remote control for the set-top box to access table of contents 40 for program 34. Once accessed, the user could then select the keyframes 64 for the sequences that have already passed. Previous systems that selected frames from programs failed to truly rely on the content of the program (as does the present invention). It should be understood that table of contents 40 depicted in FIG. 3 is intended to be exemplary only. Specifically, it should be understood that table of contents 40 could also include audio, video and/or textual content.

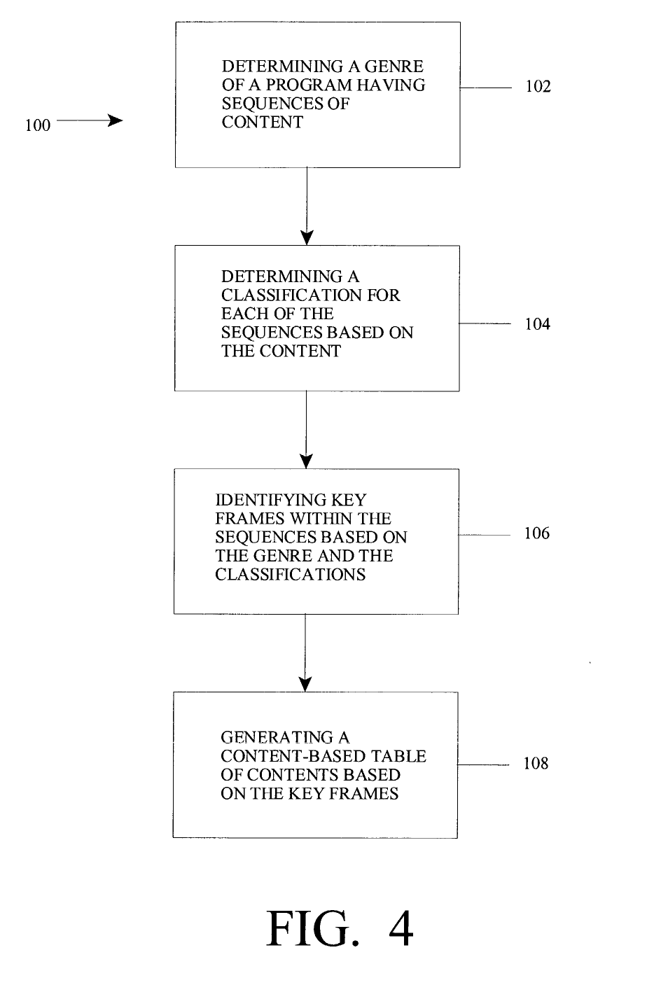

Referring now to FIG. 4, a method 100 flow diagram is shown. As depicted, first step 102 of method 100 is to determine a genre of a program having sequence of content. Second step 104 is to determine classifications for each of the sequences based on the content. Third step 106 is to identify keyframes within the sequences based on the genre and the classifications. Fourth step 108 is to generate a content-based table of contents based on the keyframes.

It is understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computerized system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the art.

1. A method for generating a content-based table of contents for a program, comprising:
determining a genre of a program having sequences of content;
determining a classification for each of the sequences based on the content;
identifying keyframes within the sequences based on the genre and the classification; and
generating a content-based table of contents based on the keyframes.

2. The method of claim 1, wherein the keyframes are identified by applying a set of rules that correlates the genre with the classifications and the keyframes.

3. The method of claim 1, wherein the step of determining a classification for each of the sequences, comprises:
reviewing the content of each of the sequences; and
assigning a classification to each of the sequences based on the content.

4. The method of claim 1, wherein the classifications are determined based on video content and audio content within the sequences.

5. The method of claim 1, wherein the table of contents further comprises audio content, video content or textual content.

6. The method of claim 1, further comprising accessing the set of rules in a database, prior to the identifying step.

7. The method of claim 1, wherein the identifying step comprises calculating a frame importance for the sequences.

8. The method of claim 1, wherein the identifying step comprises mapping the genre with the classifications to identify keyframes for the sequences.

9. The method of claim 1, further comprising manipulating the table of contents to browse the program.

10. The method of claim 1, further comprising manipulating the table of contents to access a particular sequence within the program.

11. The method of claim 1, further comprising manipulating the table of contents to access highlights of the program.

12. A method of generating a content-based table of contents for a program, comprising:
determining a genre of a program having a plurality of sequences, wherein the sequences include video content, audio content and textual content;
assigning a classification to each of the sequences based on the video content, the audio content and the textual content;
identifying keyframes within the sequences based on the genre and the classifications by applying a set of rules; and
generating a content-based table of contents based on the keyframes.

13. The method of claim 12, further comprising reviewing the video content and the audio content of the sequences to determine a classification for each of the sequences, prior to the assigning step.

14. The method of claim 12, wherein the content-based table of contents includes the keyframes.

15. The method of claim 12, wherein the set of rules correlates the genre with the classifications and the keyframes.

16. A system for generating a content-based table of contents for a program, comprising:
a genre system for determining a genre of a program having a plurality of sequences of content;
a classification system for determining a classification for each of the sequences of a program based on the content;
a frame system for identifying keyframes within the sequences based on the genre and the classifications; and
a table system for generating a content-based table of contents based on the keyframes.

17. The system of claim 16, wherein the keyframes are identified by applying a set of rules that correlates the genre with the classifications and keyframes.

18. The system of claim 16, wherein the classification system, comprises:
an audio review system for reviewing audio content within the sequences;
a video review system for reviewing video content within the sequences;
a textual review system for reviewing textual content within the sequences; and
an assignment system for assigning a classification to each of the sequences based on the audio content, the video content and the textual content.

19. The system of claim 16, wherein the table of contents comprises the keyframes determined from the applying step.

20. The system of claim 16, further comprising accessing the set of rules in a database, prior to the applying step.

21. A program product stored on a recordable medium for generating a content-based table of contents for a program, which when executed, comprises:
program code for determining a genre of a program having a plurality of sequences of content;
program code for determining a classification for each of the sequences of a program based on the content;
program code for identifying keyframes within the sequences based on the genre and the classifications; and
program code for generating a content-based table of contents based on the keyframes.

22. The program product of claim 21, wherein the keyframes are identified by applying a set of rules that correlates the genre with the classifications and keyframes.

23. The program product of claim 21, wherein the program code for determining a classification, comprises:
program code for reviewing audio content within the sequences;
program code for reviewing video content within the sequences;
program code for reviewing textual content within the sequences; and
program code for assigning a classification to each of the sequences based on the audio content, the video content and the textual content.

24. The program product of claim 21, wherein the table of contents comprises the keyframes determined from the applying step.

25. The program product of claim 21, further comprising accessing the set of rules in a database, prior to the applying step.
